(19) United States
(12) Patent Application Publication
(10) Pub. No.: US 2013/0211731 A1
(43) Pub. Date: Aug. 15, 2013

(54) MULTI-PATIENT DATA COLLECTION, ANALYSIS AND FEEDBACK

(71) Applicant: David Woltman, San Diego, CA (US)

(72) Inventor: David Woltman, San Diego, CA (US)

(21) Appl. No.: 13/759,683

(22) Filed: Feb. 5, 2013

Related U.S. Application Data
(60) Provisional application No. 61/596,730, filed on Feb. 9, 2012.

(51) Int. Cl. G06F 19/00

(52) U.S. Cl. CPC G06F 19/366
USPC 702/21; 702/19

(57) ABSTRACT

An automated method adapted to monitor and analyze patient data includes: receiving patient data from a set of patient monitoring devices; analyzing the patient data based at least partly on a set of evaluation criteria; and generating multiple status reports, each status report based at least partly on the analysis of patient data. A system adapted to collect and analyze patient data includes: multiple measurement devices, each device associated with a particular patient; a server device adapted to receive data from at least one of the measurement devices; and a storage adapted to store the received data. An automated method adapted to evaluate quality of care of patients having a chronic condition includes: receiving patient data; receiving a set of performance metrics; receiving a set of operating procedures; and generating a set of reports based at least partly on an evaluation of the patient data, performance metrics and operating procedures.

### CROSS-REFERENCE TO RELATED APPLICATIONS

This application claims priority to U.S. Provisional Patent Application Ser. No. 61/596,730, filed on Feb. 9, 2012.

### BACKGROUND

As one example of a need for improved patient care for those with chronic diseases, hospitals face serious challenges regarding managing blood glucose levels in diabetic patients while the patients are hospitalized. Such care is often suboptimal. The number of people with diagnosed and undiagnosed diabetes (and/or other chronic diseases) is increasing rapidly. As a result, annual diabetes-related spending will also increase rapidly. Without significant changes in public or private strategies, this population and cost growth are expected to significantly strain an already overburdened health care system.

Therefore, there is a need for a solution that allows a continuous flow of data among patients, doctors, hospitals, and 3^{rd} parties (e.g., insurance companies, government entities, etc.) to improve care and reduce costs.

### BRIEF SUMMARY

Broadly, an embodiment of the present invention generally provides a way to optimize patient care. Such patient care may involve inpatient care for patients with chronic disease (e.g., diabetes). In addition, various performance metrics may be associated with such care. Patient data may be received from various appropriate sources (e.g., electronic measurement devices). Such patient data may include various current and/or historical measurements associated with each particular patient. For instance, the patient data may include a series of glucose level measurements for a diabetic patient. The data may be analyzed in conjunction with various operating procedures used by a caregiving facility. The analyzed data may be presented in variously formatted reports to the appropriate caregiving resources (e.g., physicians, nurses, wards, etc.). In addition, raw data and/or analyzed data may be made available to various appropriate parties, systems, and/or resources (e.g., patients, 3^{rd}-party systems, doctors, etc.).

One exemplary embodiment of the invention provides an automated method adapted to monitor and analyze patient data. The method includes: receiving patient data from a set of patient monitoring devices; analyzing the patient data based at least partly on a set of evaluation criteria; and generating multiple status reports, each status report based at least partly on the analysis of patient data.

Another exemplary embodiment of the invention provides a system adapted to collect and analyze patient data. The system includes: multiple measurement devices, each device associated with a particular patient; a server device adapted to receive data from at least one of the measurement devices; and a storage adapted to store the received data.

Yet another exemplary embodiment of the invention provides an automated method adapted to evaluate quality of care of patients having a chronic condition. The method includes: receiving patient data from a set of patient monitoring devices; receiving a set of performance metrics associated with the patient data; receiving a set of operating procedures associated with a caregiving facility; and generating a set of reports based at least partly on an evaluation of the patient data, the set of performance metrics and the set of operating procedures.

The preceding Summary is intended to serve as a brief introduction to some embodiments of the invention. It is not meant to be an introduction or overview of all inventive subject matter disclosed in this document. The Detailed Description that follows and the Drawings (or “Figures” or “FIGs.”) that are referred to in the Detailed Description will further describe the embodiments described in the Summary as well as other embodiments. Accordingly, to understand all the embodiments described by this document, a full review of the Summary, Detailed Description and the Drawings is needed. Moreover, the claimed subject matter is not to be limited by the illustrative details in the Summary, Detailed Description and the Drawings, but rather is to be defined by the appended claims, because the claimed subject matter may be embodied in other specific forms without departing from the spirit of the invention.

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a conceptual state diagram of some embodiments;

FIG. 2 illustrates another conceptual state diagram of some embodiments;

FIG. 3 illustrates yet another conceptual state diagram of some embodiments;

FIG. 4 illustrates a schematic block diagram of a conceptual system of some embodiments;

FIG. 5 illustrates a schematic block diagram of a conceptual software system of some embodiments;

FIG. 6 illustrates a conceptual data structure diagram including a set of conceptual primary database fields used by some embodiments;

FIG. 7 illustrates an example report generated by some embodiments;

FIG. 8 illustrates another example report generated by some embodiments;

FIG. 9 illustrates yet another example report generated by some embodiments;

FIG. 10 illustrates a flow chart of a conceptual process used by some embodiments to evaluate data;

FIG. 11 illustrates a flow chart of a conceptual process used by some embodiments to collect data;

FIG. 12 illustrates a flow chart of a conceptual process used by some embodiments to provide data; and

FIG. 13 conceptually illustrates a schematic block diagram of a computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Several more detailed embodiments of the invention are described in the sections below. Section I provides a conceptual description of a system provided by some embodiments. Section II describes various types of navigable locations that may have associated audition display areas in some embodiments. Section II then describes various example reports generated by some embodiments. Next, Section III describes methods of operation used by some embodiments. Lastly, Section IV describes a computer system which implements some of the embodiments of the invention.

### I. System

Sub-section I.A provides a conceptual overview of system operation. Sub-section I.B then describes a system architecture provided by some embodiments. Lastly, sub-section I.C describes a software system architecture provided by some embodiments.

Although various specific examples may be provided below, one of ordinary skill in the art will recognize that various different embodiments may be implemented in various different ways without departing from the spirit of the invention. For example, although various examples may refer to diabetes, treatment of patients with other chronic diseases (e.g., high blood pressure, a lung condition such as asthma, bronchitis, and/or emphysema, heart disease, obesity, etc.) or conditions (or combinations of diseases and/or conditions) may be improved in various similar ways. As another example, although various examples below may refer to measurements of blood glucose levels, various other appropriate measurements may also be used (e.g., blood pressure measurements, weight, etc.).

A. Overview

Elevated glucose levels in a hospital environment may be associated with complications. Examples of these challenges include difficulty in maintaining blood glucose levels in the optimal range, vulnerability to infections, slower healing rates, increased rates of diabetic complications, dangerous episodes of hypoglycemia, transition of insulin regimen when patient moves from one care area to another, difficulty in matching proper insulin dose with meals, length of stay and readmission rates are higher for patients with diabetes, lack of standardized diabetes training for staff and physicians, and not always taking into consideration the patient's own evaluation and recommendations for their care.

These examples clearly illustrate that when a diabetic patient, for example, is admitted to the hospital, no matter the reason, an extra level of complexity exists, and it is imperative that the necessary steps are taken to assure that their diabetes is properly addressed. The growing incidence of diabetes and additional financial constraints placed on healthcare providers via healthcare reform only foretell further restrictions on the hospital's ability to provide optimum diabetes care.

The reporting system of some embodiments may be configured, for example, to track glucose levels of patients against a target range and monitor excursions out of the target range and the adverse events of hypo and hyperglycemia.

The system may be accessible using, for example, a web browser. This may allow users to access the system from various locations. The users may be able to access real time synchronized applications from mobile devices (e.g., tablet devices, laptops, and/or Smartphones).

Users may be able to access the system via the Internet as a web service that may be provided through an application service provider (“ASP”), thus eliminating installation and setup by the user. In this way, users may be able to set up and access the system very quickly.

Data may be uploaded automatically and/or manually. For instance, blood glucose meter readings may be downloaded into hospital data repositories. The system of some embodiments may have an interface which is able to sync hospital data to the system database so that data can be analyzed using the reporting application provided by some embodiments of the system in conjunction with patient, service, and unit-level information. Alternatively, blood glucose meter readings that are downloaded into the hospital data repositories may be manually uploaded into the database using the system interface of some embodiments.

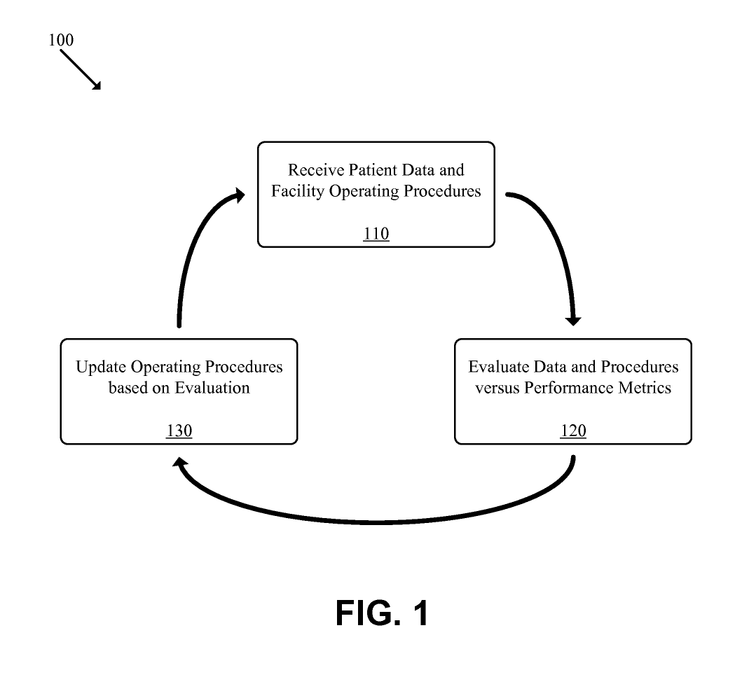

FIG. 1 illustrates a conceptual state diagram 100 of some embodiments. As shown, patient data and facility operating procedures may be received (at 110). Such patient data may include various measured biometric data (e.g., glucose level) that may be collected at various appropriate frequencies and/or volumes. The operating procedures may include target levels of compliance with various evaluation thresholds. The data and procedures may then be evaluated (at 120) versus performance metrics. Such performance metrics may include targets for patient compliance with the various evaluation thresholds. The operating procedures may then be updated (at 130) based at least partly on the evaluation performed at 120. Updates to the operating procedures may include updates to one or more thresholds, updates to performance targets, etc. The updated operating procedures may then be received, in addition to patient data received at 110, thus allowing the cycle to continue.

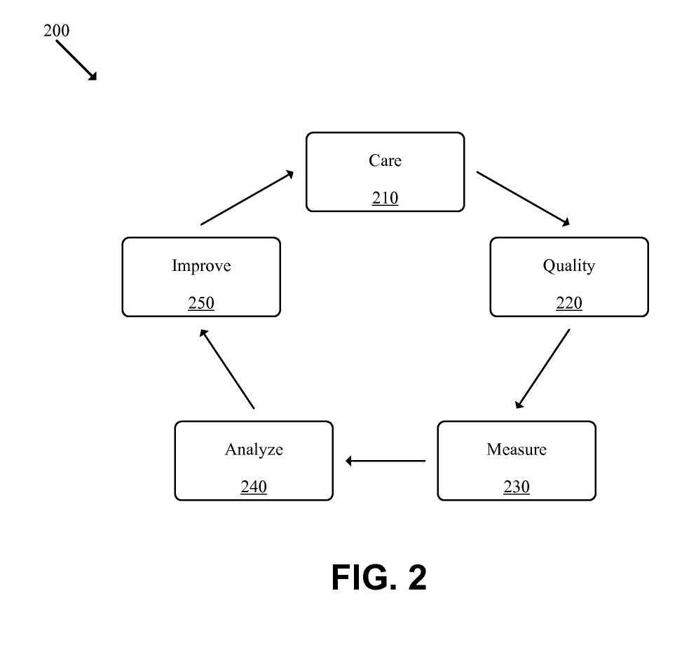

FIG. 2 illustrates another conceptual state diagram 200 of some embodiments. As shown, care 210 may be evaluated to determine the quality 220 of the care. The quality of care may be measured (at 230), analyzed (at 240) and improved (at 250) by evaluating the analysis. Such a set of states may be continuously cycled such that care is improved.

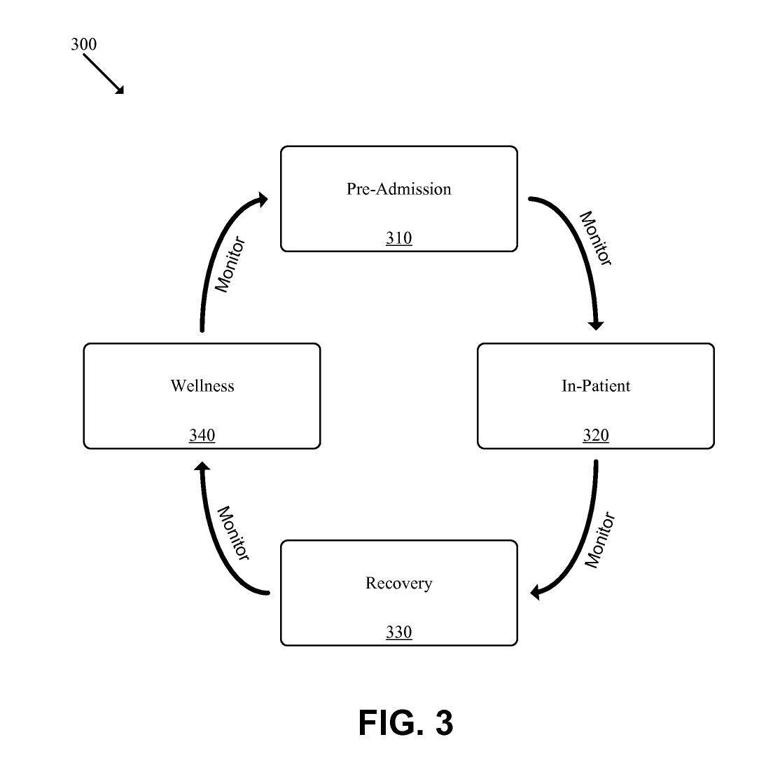

FIG. 3 illustrates yet another conceptual state diagram 300 of some embodiments. This example highlights the comprehensive monitoring and/or evaluation of care provided by some embodiments. A particular patient may be monitored from pre-admission 310 through in-patient status 320, recovery 330, and wellness 340. As shown, such wellness monitoring may proceed to pre-admission status 310, as appropriate, when a patient has been determined to need in-patient care 320.

B. System Architecture

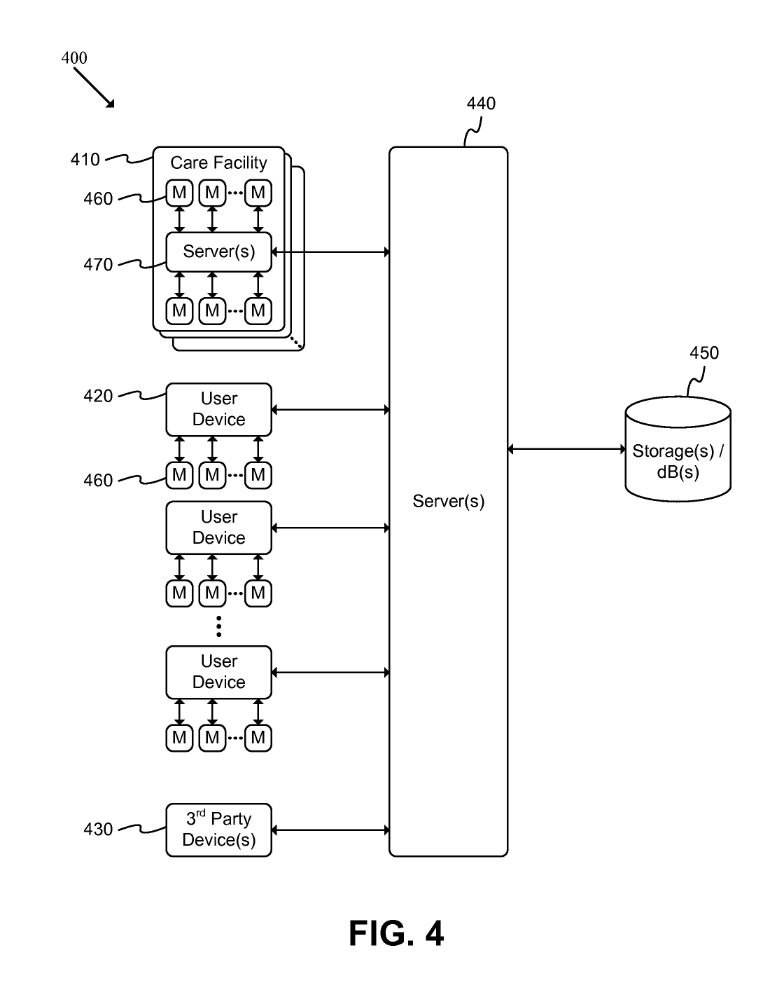

FIG. 4 illustrates a schematic block diagram of a conceptual system 400 of some embodiments. Specifically, this figure shows various distributed elements that may collectively form a comprehensive care system. As shown, system 400 may include at least one care facility 410, at least one user device 420, at least one 3^{rd} party device 430, one or more servers 440, and one or more storages or databases (dBs) 450.

Each care facility 410 (e.g., a clinic, hospital, ward, etc.) may include one or more measurement or monitoring devices 460 that may each communicate with a set of local servers 470 using various appropriate communications protocols (e.g., Ethernet, Bluetooth, Wi-Fi, etc.). Alternatively, the monitoring devices 460 may communicate directly with server 440 (e.g., across one or more networks). As another alternative, the monitoring devices 460 may communicate with various other devices (e.g., a tablet or smartphone) that may, in turn, communicate with server 440 or server 470. Similarly, each user device 420 (e.g., a smartphone, a personal computer (PC), a tablet device, etc.) may be able to communicate among one or more monitoring devices 460 and/or the server 440.

Each monitoring device 460 may be associated with one or more patients and may be able to take various measurements (e.g., blood glucose level, blood pressure, etc.) at various appropriate intervals (or continuously). The monitoring device 460 may include various electronic, software, mechanical, and/or other types of elements, as appropriate.

Each 3^{rd} party device (e.g., a PC, smartphone, etc.) may be able to communicate with the server 440. Such devices may be associated with various appropriate 3^{rd} parties (e.g., insurance companies, government agencies, etc.).

The server(s) 440 may be able to communicate among the local servers 470, user devices 420, 3^{rd}-party devices 430, monitoring devices 460, and/or the storages 450. The server 440 may include components adapted to execute software instructions and/or process data.

The storages and/or databases 450 may be adapted to store data and/or instructions and pass the data and/or instructions to and/or receive the data and/or instructions from various appropriate devices (e.g., servers 440).

Although the system 400 has been described with reference to various specific details, one of ordinary skill in the art will recognize that it could be implemented in various different ways without departing from the spirit of the invention. For instance, different embodiments may include different communication pathways, different specific modules, etc. As one example, in some embodiments, the user devices 420, 3^{rd}-party devices 430, and/or other elements (e.g., servers 470) may be able to communicate directly with the storages 450 without requiring a server 440.

C. Software Architecture

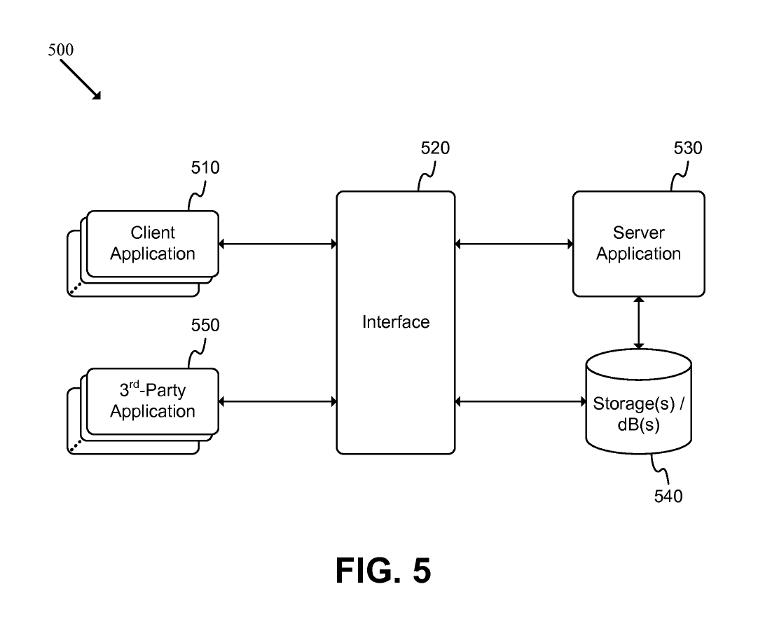

FIG. 5 illustrates a schematic block diagram of a conceptual software system 500 of some embodiments. Specifically, this figure shows the various software elements that may be executed by the components described above in reference to FIG. 4. As shown in FIG. 5, system 500 may include one or more client applications 510, one or more interfaces 520, one or more server applications 530, one or more storages and/or dBs 540, and one or more 3^{rd}-party applications 550.

Each client application 510 may be executed by an appropriate device (e.g., user device 420, server 470, etc.). Such a client application 510 may be provided as a stand-alone application or as a sub-element of another application (e.g., browser-executable code, a plug-in, etc.). The client application may be able to control and/or interface with various elements of the execution device (e.g., a communication module, local storage, etc.).

The interface 520 may include various elements (e.g., one or more application programming interfaces (APIs)) that may allow the client applications 510 and/or 3^{rd}-party applications 550 to interact with the server application 530 and/or storages 540. Such an interface 520 may work in conjunction with a stand-alone application, browser-based application, etc.

The server application 530 may be executed by an appropriate device (e.g., server 440). Such a server application 530 may interact with the interface 520, the storages and/or dBs 540, and/or the client applications 510 and/or 3^{rd}-party applications 550 (connection not shown).

The storages 540 may include various data elements that may be able to be provided to the various components of system 500.

Each 3^{rd}-party application 550 may be executed by an appropriate device (e.g., 3^{rd}-party device 430, user device 420, etc.). Such a 3^{rd}-party application 550 may be provided as a stand-alone application or as a sub-element of another application (e.g., browser-executable code, a plug-in, etc.). The client application may be able to control and/or interface with various elements of the execution device (e.g., a communication module, local storage, etc.).

Although system 500 has been described with reference to various specific details, one of ordinary skill in the art will recognize that the system may be implemented in various different ways with various different specific features.

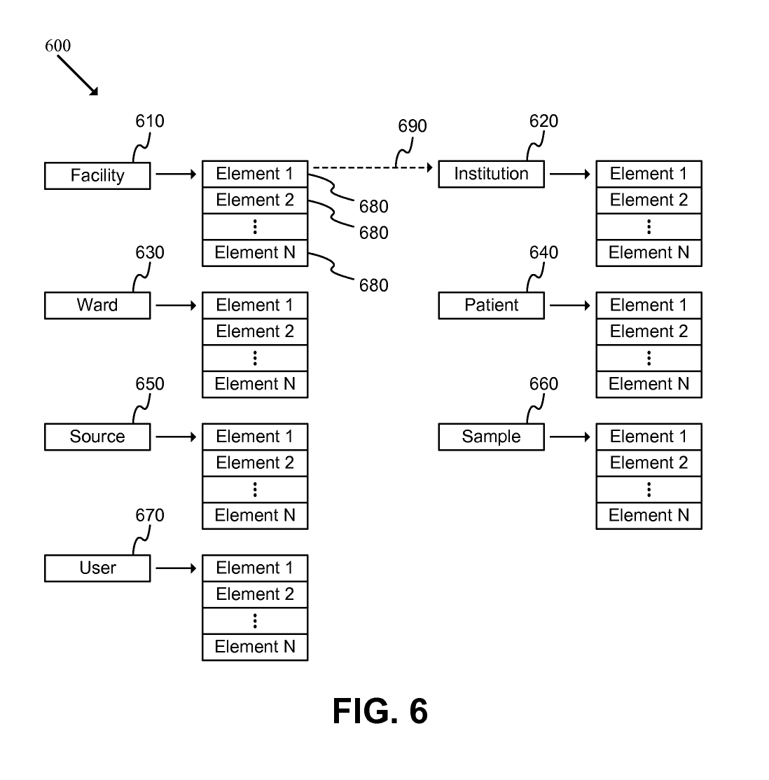

FIG. 6 illustrates a conceptual data structure diagram 600 including a set of conceptual primary database fields used by some embodiments. As shown, this example includes a facility element 610, an institution element 620, a ward element 630, a patient element 640, a source element 650, a sample element 660, and a user element 670. Each element 610-670 may include multiple sub-elements 680. In some cases, a sub-element may refer to one or more other elements. For instance, a sub-element of the facility element 610 may refer 690 to an institution element 620. (Other potential sub-element references have been omitted from FIG. 6 for clarity.)

Such database fields 610-670 may include various types of information related to a patient and/or the patient's care. As an example, a glucose-metric data model may include multiple major interrelated modules (e.g., institutional, facility, ward, patient, contact, sample, and/or source, among others). In addition, the model may include multiple core data tables (e.g., six).

Some embodiments may include an institution module 620 for tracking data related to a medical institution. The institution may be the highest level of the organization. In addition to basic demographic information, the institution module (or table) may hold data elements specific to that table. The fields may be used, for example, to track whether the institution is a for-profit or a nonprofit, a public or a private institution, etc. Various tables (e.g., institution_disclose_internal, institution_disclose_external, etc.) may be unique to the institution module. These tables may identify hierarchical data levels within the medical institution for which the institution is willing to disclose to internal or external consumers. These fields may be referenced upon the creation of reports or display of information on the screens.

Some embodiments may include a facility module 610 for tracking data related to a medical facility, or physical hospital location. A facility may be the second level of the organization, subordinate to the institution. The facility module may include various tables that are unique to the facility module, such as region and region_states tables that may hold information about relationships among various regions (e.g., states and/or Center for Disease Control (“CDC”) regions). A CDC region may not be held within the facility profile, instead the facility's region may be determined by its state and the information contained in the region and region_state tables.

Some embodiments may include a ward module 630 for tracking data related to individual ward within the medical facility, or physical hospital location. A ward may be the third level of the organization, subordinate to facility and institution. A ward may not include address information about the physical location of the ward. Instead, the ward may be presumed to reside within the same physical structure as the facility. The ward sub-module may have three unique table relationships. The specialty table may hold information about any special medical services the ward may provide, for example, oncology. The population table may hold detailed information describing the patient population within that ward (e.g., geriatric). The unit table holds information describing any unique characteristic about the ward, for example, whether the ward is a medical school training center. The tables may include a field location id, which can be used to identify the floor or location within a floor (e.g., floor 17, North wing) that the ward occupies.

Some embodiments may include a patient module 640 for tracking data related to one or more individual patients. The patient may not be directly linked to a ward within the medical facility. The relationship between patient and ward, facility and institution may exist upon the gathering of a sample. This allows patient tracking as patients move within and/or among various wards and/or facilities without losing the ability to monitor ward or facility level data.

The patient module may be centered around the patient table. The unique identifier may be patient_id. Additionally, the patient_id may hold valid types of personal (patient and contact) identification. The table patient_id may hold the relationship between the patient and ID tables. This data structure allows all patient confidential information to be held within a single table and utilizes the non-identifiable serial patient id throughout all other modules and for reporting.

The ID table may hold information about different types of patient identification documents. For example, driver's license, social security number, insurance provider, policy numbers, patient record numbers, etc. may be included.

The patient profile table may include detailed demographic information about the individual patient, including name, address, phone, cell phone and fax number. In addition to demographic information it also contains physical information related to the patient, including their sex, race, date of birth, height, weight, body mass index (“BMI”), etc.

The patient_monitor table may include information that allows for, for example, establishing a begin and end time for monitoring a patient. By utilizing this table, the notices sent out to contacts for a lack of samples, as established by level or frequency (e.g. patient_frequency, ward_frequency, facility_frequency or institution_frequency may be withheld). Diagnostic and patient_diagnostic information may be linked to the patient_monitor table. Diagnostic may hold diagnostic codes (e.g., Source 9 from the CDC). And the table patient_diagnostic may hold the relationship between patient and diagnostic.

Some embodiments may include a contact module (not shown) for tracking data related to individual person(s) who may be associated with a patient. This contact may include the patient themselves, the patient's guardian(s), individuals with medical powers of attorney, private physicians, and/or hospital staff. Each unique patient contact relationship may allow for different levels of notification. The contact module may have two unique table relationships. In the table relationship the relationship between a contact and a patient is identified, this allows a contact to be linked to multiple patients. The table relationship_type identifies allowable contact descriptions. For example: self, parent, medical staff.

Some embodiments may include a sample module 660 for tracking data related to the biological and biophysical sample. The table may include the value of that sample its value_id. The sample may be tied back to the individual patient through the patient_id and as previously described, the sample may be associated to the ward where the sample was taken.

Some embodiments may include a source module 650 for tracking the data format of the raw source data of which may originate at the institutional, facility, ward or individual patient levels as it is uniquely identified in the instution_data, facility_data, ward_data, and patient_data tables. The table may include, for example, the value of that sample and its value_id. The sample may be associated with the individual patient through the patient_id and as previously described, the sample may be associated to the ward where the sample was taken.

The source_data table may be linked to source through the source_id field. This table may include information about the individual data fields for an individual data source. Once populated with the field record layouts from the various data sources. Source_data can be used to dynamically parse data from different data sources within the medical institution. Field record layouts for the multiple data sources may come from internal hospital systems or medical hardware device manufacturers.

Some embodiments may include a user module 670 and associated table for tracking information about users who may be involved with the entry of data into the system and/or the consumption of its reports. The user table may include demographic information about the human user, including the department with which the user is associated, an internal employee_id, email address, etc. Additionally, individual user permission levels are held in various detail tables, (e.g., user_ward, user_facility and user_instution). This field may interface to the institution_disclose_internal fields in order to determine which data sets the user is entitled to input or access.

Some embodiments may include hierarchal replicated tables (e.g., institution_level, facility_level, ward_level, and/or patient_level). These tables may allow comparison of samples of various rules set at different levels of the institution. Multiple criteria may be set for each hierarchical level within the institution. Each rule contains low and high threshold as well as a description for each range. When a sample is taken it will first be applied to the rules set up in the patient_level table. If the patient level does not exist then the sample will be compared to the ward_level rules should they not exist the sample be applied to the facility_level rules and finally in the absence of facility level rules the sample will be applied to the institution's rules. At each level where a sample is meets a rule, based upon that individual rule, it may trigger issuance of a notice to a contact identified the relationship table.

Various other tables (e.g., institution_data, facility_data, ward_data, and/or patient_data) may be used by some embodiments to identify the source of sample data which may be generated at different levels of the institution. For example, the system may obtain data from an individual patient from their personal meter. Or once admitted to a facility, samples maybe received from different wards within that facility that use different data collection methods.

This data may be associated to the source and source_data tables for dynamic parsing of those multiple data sources and may be used to identify the frequency for which a sample data may be required at different levels of the institution. For example, the system may require data from an individual patient on an hourly basis, or a ward may require it on a daily basis.

Some embodiments may have a table that includes the serial notice_id field and the notice_description. This data is accessed by the institutional_level facility_level ward_level and patient_{—} level tables to ascertain whether a notice needs to be generated to any contact as defined in the relationship table.

Some embodiments may have a state table that may hold the United States Postal Service two character codes for all U.S. states and colonies. Some embodiments may have a country table that may hold the names of all countries identified by the United Nations. Additionally this table may hold the internationally recognized postal abbreviation and the international phone access code for that country.

Some embodiments may have a carrier table that may include information about cell phone carriers that is necessary for sending text messages to that cell phone device.

Some embodiments may have a value table that may be used to identify the unit of measure associated with data in the sample, facility level, institution level, ward level, and patient level tables. This unit of measure may include parts per million, etc. This flexibility allows for the collection and analysis of multiple diseases.

Various other data tables may be included in some embodiments (e.g., carrier, country, diagnostic, id, notice, population, race, region, region_state, relationship type, speciality, state, value, ward type, etc.). Various core data interface tables may be included in some embodiments (e.g., source, source_data, etc.). Various hospital core data tables may be included in some embodiments (e.g., institution, institution_disclose_internal, institution_disclose_external, institution_level, institution_data, institution_frequency, facility, facility_level, institution_frequency, ward, ward_level, ward_data, ward frequency, etc.).

Some embodiments may include hospital dynamic data tables such as patient, patient_level, patient_data, patient_frequency, patient_diagnostic, contact, relationship, sample, etc.

Although various example data structures have been presented in FIG. 6, one of ordinary skill in the art will recognize that various other data structures with various other elements may be used in place of, or in conjunction with, those described in diagram 600.

### II. Example Reports

Various example reports with various components are described below. Such reports may be generated based at least partly on data collected by the systems of FIGS. 4-5. Such collected data may be stored using the data structures described above in reference to FIG. 6. One of ordinary skill in the art will recognize that various different specific styles, layouts, etc. may be used without departing from the spirit of the invention.

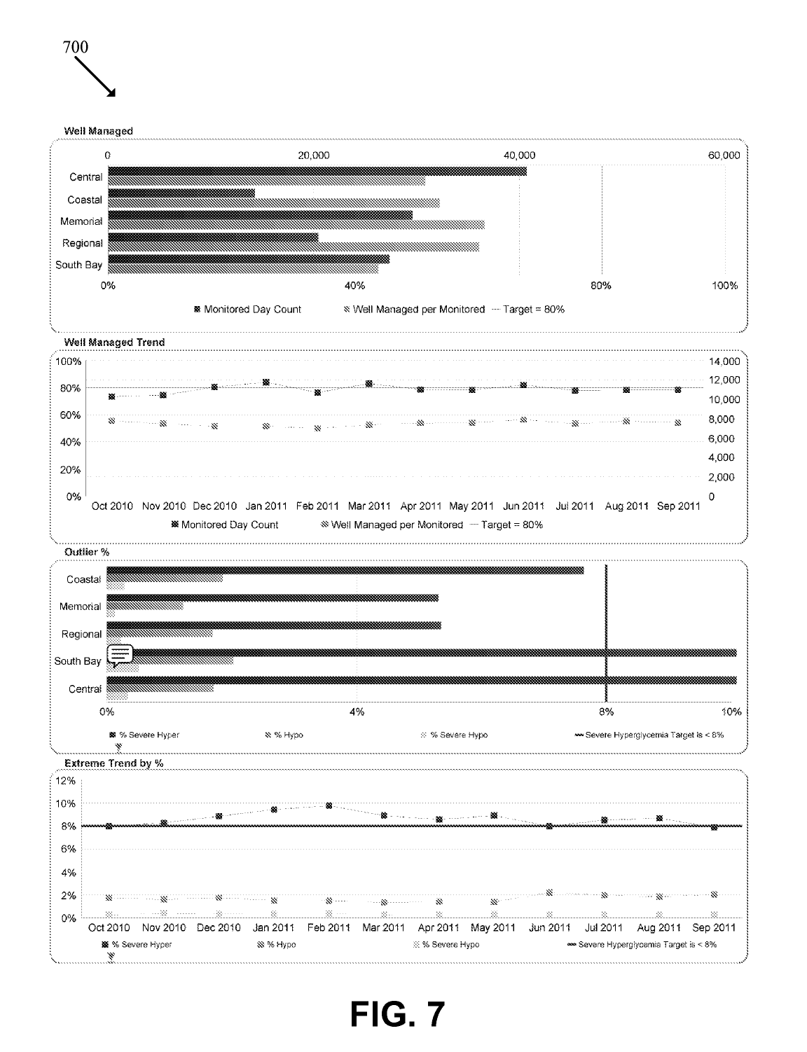

FIG. 7 illustrates an example report 700 generated by some embodiments. As shown, the report includes a bar graph depicting the percentage of well-managed patients associated with various facilities. In addition, a count associated with a number of measurements associated with each facility is shown. The report also includes a trend chart showing the percentage of well-managed patients over time (and a measurement count associated with each trend point). The report further includes a bar chart depicting the percentage of outlier measurements associated with each facility (and a measurement count associated with each facility). Furthermore, the report includes a trend chart showing the percentage of extreme measurements over time. In this example, the extreme measurements are divided into various specific types of extreme measurement (severe hyper, hypo, severe hypo, and severe hyperglycemic).

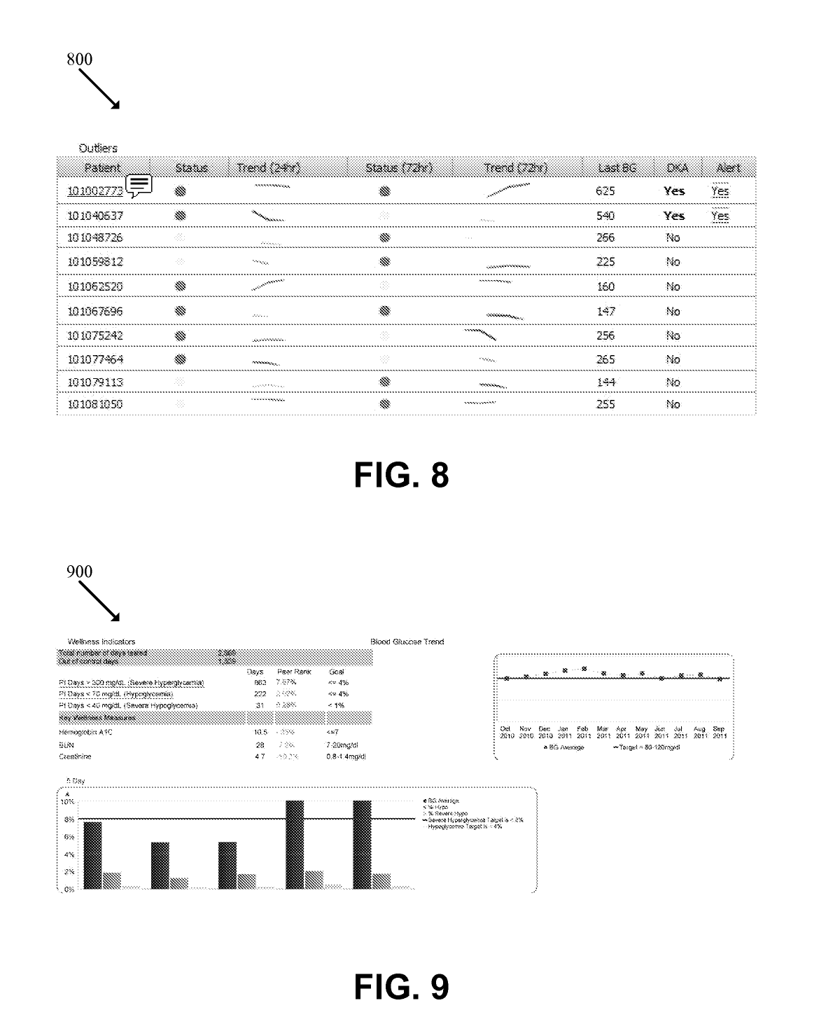

FIG. 8 illustrates another example report 800 generated by some embodiments. In this example, each line of the chart corresponds to a patient with an outlier status. Such a status may be determined by comparing a measured value associated with the patient to a set of threshold values. In the example report 800, each patient has a current status indication (in this example, differently colored circles may indicate different statuses), a 24-hour trend line, a 72-hour status indication, a 72-hour trend line, a most recent measured value (blood glucose in this example), an indication of whether the patient is experiencing diabetic ketoacidosis (or another event associated with a particular disease or condition), and an alert indication.

Various data events may trigger various appropriate alert indications, status indications, etc. For instance, some embodiments may trigger an alert when a measured value exceeds a threshold. As another example, some embodiments may trigger an alert when a measured value exceeds a threshold for a minimum length of time. Such thresholds may be based on various appropriate factors (e.g., type of measured data being evaluated, status, history, and/or demographic information regarding the patient, information related to a care facility treating the patient, etc.).

FIG. 9 illustrates yet another example report 900 generated by some embodiments. As shown, this example report includes a performance summary table, a trend chart and a 5-day snapshot illustrating the percentage of patients identified as exceeding one or more thresholds.

As shown, these reports 700-900 summarize various data elements associated with patient care. Different embodiments may determine and present report data in various different ways.

### III. Methods of Operation

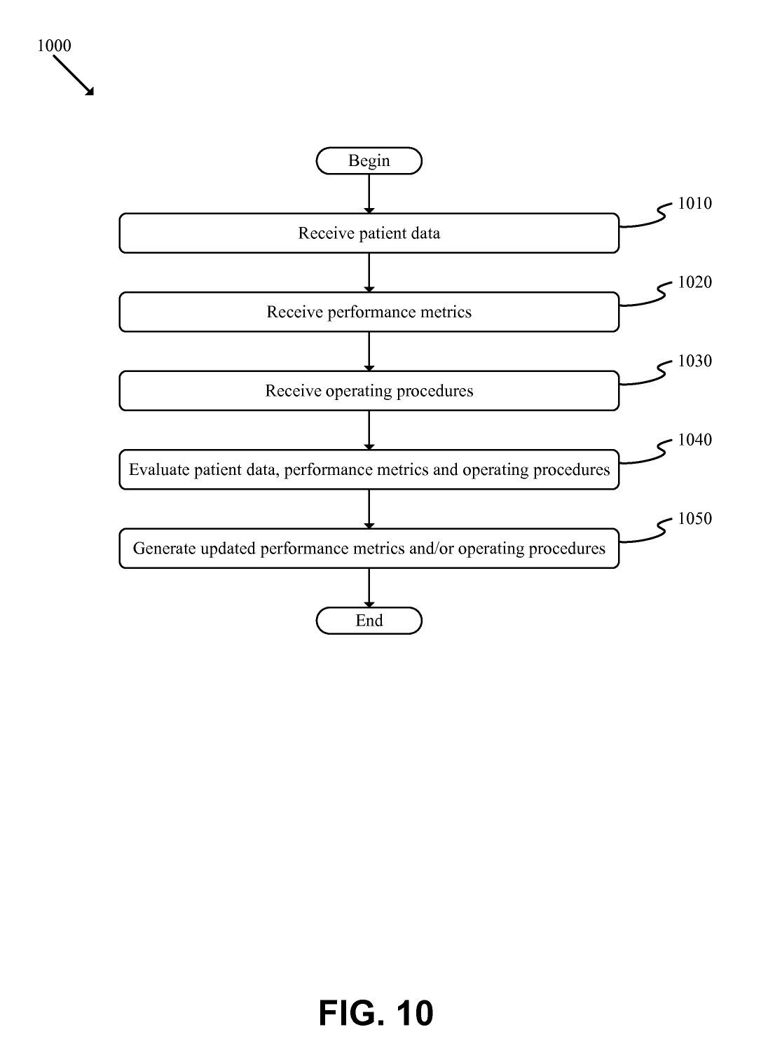

FIG. 10 illustrates a flow chart of a conceptual process 1000 used by some embodiments to evaluate data. The process may begin when a user attempts to access patient information, when a measurement of patient data is received, and/or at other appropriate times. As shown, the process may receive (at 1010) patient data (e.g., a blood glucose measurement, a blood pressure measurement, etc.). Such data may be received from, for instance, one or more measurement devices 460 described above in reference to FIG. 4.

Alternatively and/or conjunctively, data may be collected from various appropriate repositories (e.g., storage 450). The process may then receive (at 1020) various performance metrics (e.g., minimum and maximum glucose level). Next, the process may receive (at 1030) various operating procedures (e.g., procedures for monitoring and managing glucose levels). The process may then evaluate (at 1040) the patient data, performance metrics and operating procedures. Such evaluation may include various forms of statistical analysis. The process then may generate (at 1050) updated performance metrics and/or operating procedures based on the evaluation at 1040 and then may end.

In some embodiments, process 1000 may be used to monitor patient data in real time and may provide one or more alerts to various interested parties (e.g., doctors, nurses, etc.) as appropriate. The process may begin when, for example, a caregiver activates monitoring of a patient, when a patient is admitted, etc. The process may then receive (at 1010) patient data in real-time (or at a nominal delay). Next, the process may receive (at 1020) various performance metrics. Such performance metrics may include various operating thresholds (e.g., an action may be triggered when the patient data exceeds some threshold, exceeds a threshold for a minimum time period, etc.). The process then may receive (at 1030) operating procedures. Such operating procedures may include various specified responses to any triggered actions (e.g., the type and destination of a notification). The process may then evaluate (at 1040) the patient data, performance metrics, and operating procedures. Such evaluation may include, for example, comparing the patient data to one or more thresholds, measuring a change in patient data over time, etc. The process may then generate (at 1050) updated performance metrics and/or operating procedures, which in this example may include generating and delivering various notifications to interested caregivers.

One of ordinary skill in the art will recognize that process 1000 may be performed in various different ways without departing from the spirit of the invention. For instance, in some embodiments the process may be performed as several distinct sub-processes. As another example, in some embodiments the process may be performed as a sub-process of another process. In addition, the various operations of process 1000 may be performed in different orders, various operations may not be performed and/or other operations may be performed, as appropriate.

In some embodiments, the evaluation (at 1040) of process 1000 may be used to tabulate and compare performance within and/or among various operational units (e.g., caregiver, ward, facility, institution, region, etc.). In this way, various units may be ranked and/or otherwise compared at least partly based on their performance versus pre-determined and/or evolving metrics. Such performance comparisons may consider various appropriate factors. For instance, units may be compared based on patient data, performance metrics, and/or operating procedures. Such comparisons may be based on current, historical, and/or combinations of present and past performance.

As one example, some various units may be compared and ranked based on their relative performance at maintaining desired blood glucose levels in diabetic patients. The comparisons and/or rankings may consider various appropriate factors such as number of patient-hours within a set of thresholds (e.g., to determine the percentage time within acceptable thresholds as set by procedures or guidelines), number of incidences of patients exceeding thresholds (e.g., critical thresholds, incidents requiring caregiver intervention, etc.), and/or overall performance regarding maintaining a set of patients within a set of performance metrics (e.g., reducing a number of patients that exceed a particular threshold in a particular unit over a particular time period).

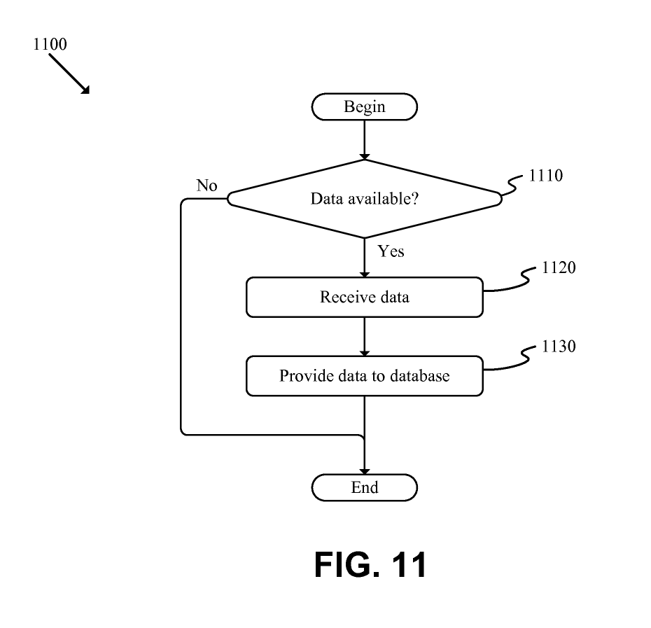

FIG. 11 illustrates a flow chart of a conceptual process 1100 used by some embodiments to collect data. Such a process may begin, for instance, when a measurement device is connected to a patient, when a measurement device or server connects to a network, and/or at other appropriate times.

Next, the process 1100 may determine (at 1110) whether data is available. Such a determination may be made in various appropriate ways. For instance, in some cases a measurement device may send a signal indicating that a measurement is available for retrieval. As another example, a measurement device may send a measurement to a local server which, in turn, may indicate to a remote server that data is available for upload. As yet another example, a user may provide a manual indication that a measurement is available. As still another example, some embodiments may attempt to retrieve data at regular intervals.

If the process determines (at 1110) that data is not available, the process may end. Alternatively, the process may run continuously and/or periodically, such that if no data is available, the process may wait some period of time before determining if data is available (or wait for some condition to be satisfied, such as receiving a signal from a measurement device indicating that new data is available).

If the process determines (at 1110) that data is available, the process may then receive (at 1120) the data and provide (at 1130) the data to a database (e.g., storages 450) and then end. Alternatively, after providing (at 1130) the data to the database, the process may repeat operations 1110-1130 continuously, at regular intervals, or as otherwise appropriate.

One of ordinary skill in the art will recognize that process 1100 may be performed in various different ways without departing from the spirit of the invention. For instance, in some embodiments the process may be performed as several distinct sub-processes. As another example, in some embodiments the process may be performed as a sub-process of another process. In addition, the various operations of process 1100 may be performed in different orders, various operations may not be performed and/or other operations may be performed, as appropriate.

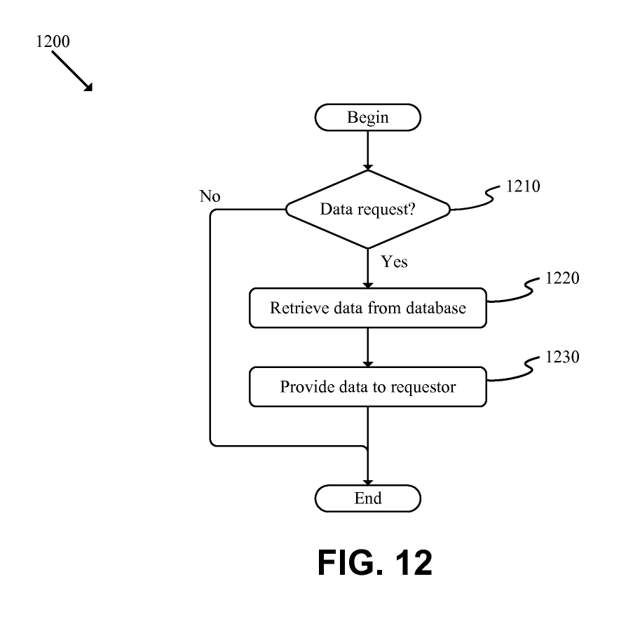

FIG. 12 illustrates a flow chart of a conceptual process 1200 used by some embodiments to provide data. Such a process may begin, for instance, when a user device or 3^{rd} party device requests data from the server or storage of some embodiments, when a user device connects to a network, and/or at other appropriate times.

Next, the process 1200 may determine (at 1210) whether data has been requested. Such a determination may be made in various appropriate ways. For instance, in some cases a user device may send a message indicating that some data is requested. As another example, a local server may request data from a remote server. As yet another example, a user may provide a manual request for data. As still another example, some embodiments may provide data to various resources at regular intervals.

If the process determines (at 1210) that data has not been requested, the process may end. Alternatively, the process may run continuously and/or periodically, such that if no data is requested, the process may wait some period of time before determining if data is requested (or wait for some condition to be satisfied, such as receiving a signal from a user device indicating that data is requested).

If the process determines (at 1210) that data has been requested, the process may then retrieve (at 1220) the data from a database (e.g., storage 450) and provide (at 1230) the data to the requestor (e.g., a user device, a 3^{rd}-party device, a local server, etc.) and then end. Alternatively, after providing (at 1230) the data to the requestor, the process may repeat operations 1210-1230 continuously, at regular intervals, or as otherwise appropriate.

As another alternative, some embodiments may analyze the retrieved data before providing the data to the requestor. Such analysis may involve comparing the retrieved data to various thresholds, determining whether a patient, facility, and/or some other entity associated with the data meets some criteria for inclusion (e.g., a request may specifically ask for only patient suffering from diabetes who are also over the age of fifty).

One of ordinary skill in the art will recognize that process 1200 may be performed in various different ways without departing from the spirit of the invention. For instance, in some embodiments the process may be performed as several distinct sub-processes. As another example, in some embodiments the process may be performed as a sub-process of another process. In addition, the various operations of process 1200 may be performed in different orders, various operations may not be performed and/or other operations may be performed, as appropriate.

### IV. Computer System

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

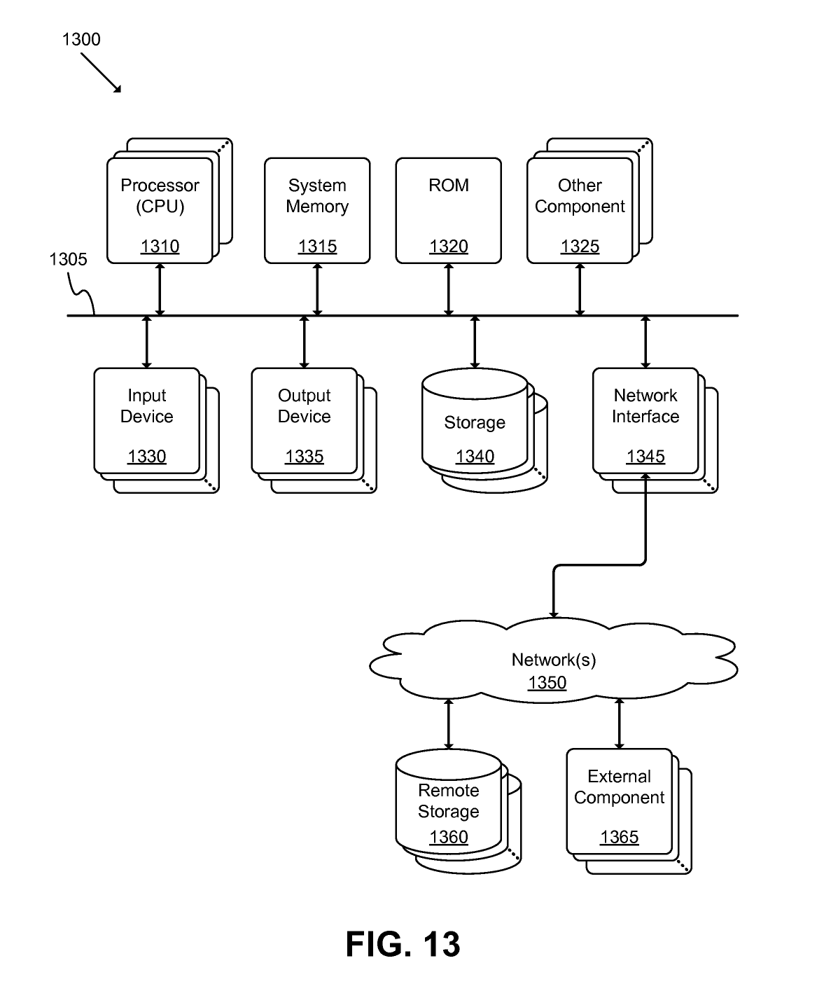

FIG. 13 conceptually illustrates a schematic block diagram of a computer system 1300 with which some embodiments of the invention may be implemented. For example, the system described above in reference to FIG. 4 or 5 may be at least partially implemented using computer system 1300. As another example, the processes described in reference to FIGS. 10-12 may be at least partially implemented using sets of instructions that are executed using computer system 1300.

Computer system 1300 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 1300 may include a bus 1305, at least one processing element 1310, a system memory 1315, a read-only memory (“ROM”) 1320, other components (e.g., a graphics processing unit) 1325, input devices 1330, output devices 1335, permanent storage devices 1340, and/or network interfaces 1345. The components of computer system 1300 may be electronic devices that automatically perform operations based on digital and/or analog input signals.

Bus 1305 represents all communication pathways among the elements of computer system 1300. Such pathways may include wired, wireless, optical, and/or other appropriate communication pathways. For example, input devices 1330 and/or output device: 6458.002-01 coupled to the system 1300 using a wireless connection protocol or system. The processor 1310 may, in order to execute the processes of some embodiments, retrieve instructions to execute and data to process from components such as system memory 1315, ROM 1320, and permanent storage device 1340. Such instructions and data may be passed over bus 1305.

ROM 1320 may store static data and instructions that may be used by processor 1310 and/or other elements of the computer system. Permanent storage device 1340 may be a read-and-write memory device. This device may be a non-volatile memory unit that stores instructions and data even when computer system 1300 is off or unpowered. Permanent storage device 1340 may include a mass-storage device (such as a magnetic or optical disk and its corresponding disk drive).

Computer system 1300 may use a removable storage device and/or a remote storage device as the permanent storage device. System memory 1315 may be a volatile read-and-write memory, such as a random access memory (“RAM”). The system memory may store some of the instructions and data that the processor uses at runtime. The sets of instructions and/or data used to implement some embodiments may be stored in the system memory 1315, the permanent storage device 1340, and/or the read-only memory 1320. For example, the various memory units may include instructions for analyzing patient data in accordance with some embodiments. Other components 1325 may perform various other functions. These functions may include, for example, interfacing with a variety of medical devices.

Input devices 1330 may enable a user to communicate information to the computer system and/or manipulate various operations of the system. The input devices may include keyboards, cursor control devices, audio input devices and/or video input devices. Output devices 1335 may include printers, displays, and/or audio devices. Some or all of the input and/or output devices may be wirelessly or optically connected to the computer system.

Finally, as shown in FIG. 13, computer system 1300 may be coupled to a network 1350 through a network interface 1345. For example, computer system 1300 may be coupled to a web server on the Internet such that a web browser executing on computer system 1300 may interact with the web server as a user interacts with an interface that operates in the web browser. In some embodiments, the network interface 1345 may include one or more APIs.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 1300 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. An automated method adapted to monitor and analyze patient data, the method comprising:
receiving patient data from a set of patient monitoring devices;
analyzing the patient data based at least partly on a set of evaluation criteria; and
generating a plurality of status reports, each status report based at least partly on the analysis of patient data.

2. The automated method of claim 1, wherein the patient data comprises blood glucose measurements.

3. The automated method of claim 1, wherein the patient data comprises biographical information related to each patient.

4. The automated method of claim 1, wherein the patient data comprises a chronic condition.

5. The automated method of claim 4, wherein the chronic condition is diabetes.

6. The automated method of claim 1 further comprising providing the status reports to a set of caregiving resources.

7. The automated method of claim 1, wherein the evaluation criteria comprises a set of measurement thresholds.

8. A system adapted to collect and analyze patient data, the system comprising:
a plurality of measurement devices, each device associated with a particular patient;
a server device adapted to receive data from at least one of the measurement devices in the plurality of measurement devices; and
a storage adapted to store the received data.

9. The system of claim 8, wherein a set of measurement devices from among the plurality of measurement devices is associated with a care facility.

10. The system of claim 9 further comprising a local server device associated with the care facility, the local server device adapted to communicate among the set of measurement devices and the server device.

11. The system of claim 8, wherein the particular patient is associated with a chronic condition.

12. The system of claim 11, wherein the chronic condition is diabetes.

13. The system of claim 8 further comprising a user device associated with the particular patient, wherein a set of measurement devices from among the plurality of measurement devices is associated with the user device.

14. The system of claim 8 further comprising at least one 3^{rd}-party device that is able to communicate with the server device.

15. An automated method adapted to evaluate quality of care of patients having a chronic condition, the method comprising:
receiving patient data from a set of patient monitoring devices;
receiving a set of performance metrics associated with the patient data;
receiving a set of operating procedures associated with a caregiving facility; and
generating a set of reports based at least partly on an evaluation of the patient data, the set of performance metrics and the set of operating procedures.

16. The automated method of claim 15 further comprising generating an updated set of operating procedures based on the set of reports.

17. The automated method of claim 15 further comprising generating an updated set of performance metrics based on the set of reports.

18. The automated method of claim 15, wherein the set of reports comprises a well-managed trend chart.

19. The automated method of claim 15, wherein the patient data comprises a set of blood glucose measurements.

20. The automated method of claim 19, wherein the chronic condition is diabetes.
